(19) United States
(12) Patent Application Publication
(10) Pub. No.: US 2015/0186957 A1
(43) Pub. Date: Jul. 2, 2015

(54) METHODS AND SYSTEMS FOR ESTIMATING LENGTH OF QUEUES BASED ON LOCATION DATA FROM MOBILE DEVICES

(71) Applicant: GOOGLE INC., (US)

(72) Inventors: John M. Barr, Courtice (CA); Geon Hyuk Park, Mississauga (CA)

(73) Assignee: GOOGLE INC., Mountain View, CA (US)

(21) Appl. No.: 13/873,473

(22) Filed: Apr. 30, 2013

Related U.S. Application Data
(60) Provisional application No. 61/653,875, filed on May 31, 2012.

(51) Int. Cl. G06Q 30/02

(52) U.S. Cl. CPC G06Q 30/0281

(57) ABSTRACT

Systems, methods and computer program products for using location data from mobile devices to estimate the length of queues for a resource are described herein. An embodiment includes identifying a queue location for a resource, receiving a plurality of periodic updates from a plurality of mobile devices in the queue location, each periodic update including an identification and a position of the mobile device and a time of measurement, and storing the identification, location and time of measurement for each device in a queue data structure. The embodiment further includes determining when a device exits the queue location and moving the stored information for that device from the queue data structure to an exit data structure. Methods are provided for using the information in the data structures to estimate the length of the queue, waiting time and the speed of the line.

### CROSS-REFERENCE TO RELATED APPLICATION

This application claims priority to U.S. Provisional Patent Application No. 61/653,875, filed on May 31, 2012, and titled “Methods and Systems for Estimating Length of Queues Based on Location Data from Mobile Devices,” the entire disclosure of which is hereby expressly incorporated by reference herein.

### FIELD OF THE DISCLOSURE

Embodiments generally relate to estimating length of queues and waiting times based on location data from mobile devices.

### BACKGROUND

People visiting or planning to visit amusement parks like to know the waiting times for various attractions so they can plan their vacations or schedules to avoid long waiting times. Amusement park operators provide information in various ways to help people plan their schedules. For example, some operators keep annual statistics of attendance and waiting times and use them to forecast attendance and waiting times at future dates. People can view the forecasts to help them make their plans.

Park operators also use various means to provide current information on waiting times, which might be available only at the site of the attraction. A person might be given a hand held device that starts measuring time when the person enters the queue and stops the time measurement when the person hands the device to an attendant before entering an attraction. The results can be posted near the attraction. Operators also often post an expected waiting time near the attraction, with the expected waiting time based on the position of the last person in the queue and empirical metrics corresponding to that position. However, the posted values might not be available to people in other parts of the park or outside the park, and may not accurately reflect real-time line dynamics. Mobile device applications are also available for some parks which allow people to enter waiting times that they have experienced at various attractions and to view waiting times entered by other people.

Many different solutions are used to provide people with information about waiting times for attractions at amusement parks. In some cases, users provide the information with the attendant delays and possible errors. In other cases operators post waiting time, but the post may be available only to people near the attraction. In general, the waiting time information is not gathered automatically, it may not be current and it may not be widely available.

### SUMMARY

Systems, methods and computer program products for using location data from mobile devices to estimate the length of queues and waiting times for a resource are described herein. An embodiment includes identifying a queue location for a resource, receiving a plurality of periodic updates from a plurality of mobile devices in the queue location, each periodic update including an identification and a position of the mobile device and a time of measurement, and storing the identification, location and time of measurement for each device in a queue data structure. The embodiment further includes determining when a device exits the queue location and moving the stored information for that device from the queue data structure to an exit data structure. Methods are provided for using the information in the data structures to estimate the length of the queue, waiting times and the speed of the line. The estimates are available from a web server and can be accessed to find waiting times for various rides in an amusement park.

### BRIEF DESCRIPTION OF THE DRAWINGS

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 shows an example system for determining queue lengths and waiting times for a resource based on location data from mobile devices.

FIG. 2 shows users assigned to queue locations in a resource area.

FIG. 3 is an aerial view of a queue location.

FIG. 4 shows users queuing for a resource.

FIG. 5 shows example data structures for storing queues and computing queue lengths and waiting times.

FIG. 6 shows an example plot for computing the average speed of the line.

FIG. 7 is a flowchart illustrating a method, according to an embodiment.

FIG. 8 illustrates an example computer useful for implementing components of the embodiments.

### DETAILED DESCRIPTION

While the present invention is described herein with reference to the illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments whether or not explicitly described.

Embodiments relate to using location data from mobile devices to estimate queue lengths and waiting times for users queuing for a resource in a resource area. Each resource has a queue location where users queue to use the resource. As an example, a resource area can be an amusement park and a resource can be a ride within the amusement park. In other examples, the resource area can be a convention center with the resource being a stage area, the resource area can be a museum with the resource being a particular exhibit, or the resource area can be a sidewalk area and the resource can be a restaurant. One of skill in the art will recognize that many other combinations of resource areas and resources that may be subject to queues may be contemplated by embodiments disclosed herein. In an embodiment each queue location is defined by a polygon and the resource area is defined by a polygon.

One or more of the users in the resource area carry a mobile device that periodically sends an update to a computer. The update contains the identification and location of the mobile device and the time of measurement of the location. The location data is used to determine whether or not the device is in a queue location.

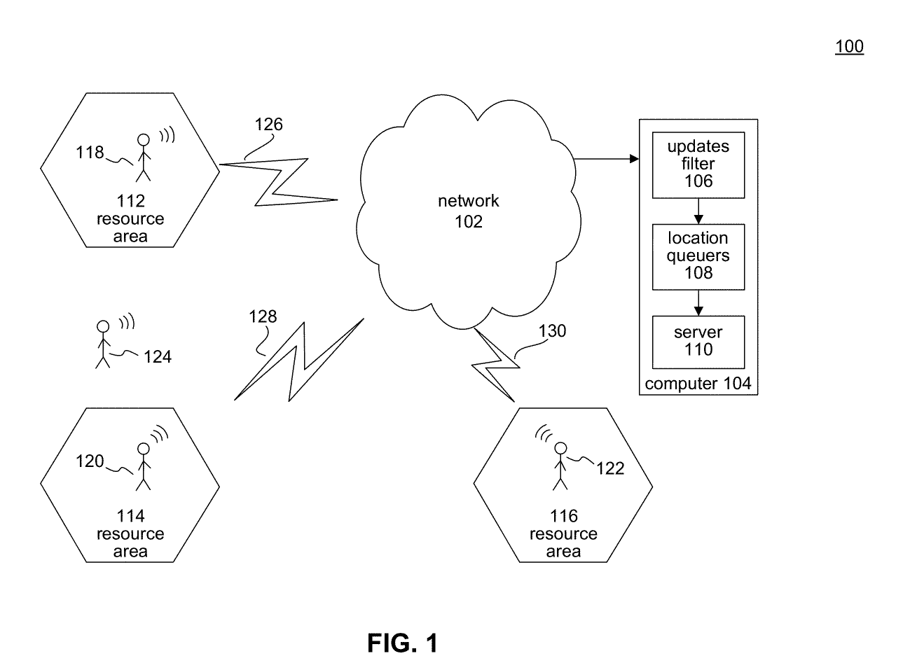

FIG. 1 shows a system for determining queue length and waiting times using location data from mobile devices. The waiting times include an estimate of the waiting time for a device at the end of the queue and a measured waiting time for the device after it exits the queue location,

FIG. 1 shows resource area 112, resource area 114, and resource area 116. Each resource area has one or more resources and associated queue locations. As an example, a resource area can be an amusement park, a resource can be a ride, and a queue location can be the line-up area for the ride.

User 118 is a person in resource area 112 with a mobile device that sends periodic updates containing its identification, its location and the time of measurement of the location. Similarly, user 120 and user 122 are in resource area 114 and resource area 116, respectively, and each has a mobile device sending updates. User 124 is not in a resource area but has a mobile device sending updates.

Each update is transported by wireless network 126, wireless network 128, or wireless network 130 to network 102 which transports it to computer 104. Computer 104 receives the updates from network 102.

Network 102 includes one or more networks such as the internet or networks that connect to the internet. In some examples, network 102 can include one or more wide area networks or local area networks and operate via one or more network technologies such as Ethernet, Fast Ethernet, Gigabit Ethernet, a variant of IEEE 802.11 such as WiFi and the like.

Wireless network 126, wireless network 128 and wireless network 130 include any wireless network that provides access to network 102 and that provides data transmission, such as 3G, 4G, WiFi and the like. The wireless networks can include one or more wireless carriers. Users in a resource area can have access to one or more wireless carriers.

The mobile devices used by user 118, user 120, user 122 and user 124 can be any mobile device that is able to determine its location and periodically send its location, time of measurement and its identity to computer 104. Since the time for some mobile devices can be set manually, time measurements can be in error. Each received measurement is checked by computer 104 relative to its clock time. If the magnitude of the difference between the measured time and the clock time is greater than a threshold (such as one minute), the measured value may be changed to the clock time.

The mobile device can use Global Positioning System (GPS) or WiFi Positioning System (WPS) information to determine its location. With those systems, latitude and longitude coordinates are determined for the location of the device and sent in the update to computer 104. The update can include a location circle centered on the latitude and longitude coordinates. The circle defines an area in which the mobile device may be located based on the measured coordinates.

Computer 104 includes updates filter 106, location queuers 108 and server 110. Server 110 is a web server that can be accessed by users to view parameters such as estimated and measured waiting times for queue locations. The parameters are stored. The parameters may be stored and/or viewed in any number of formats. For example, the parameters can be stored and/or viewed by time of day and day of week for current and historical data.

Updates filter 106 processes received updates and either assigns them to a resource area and queue location or discards them. For example, updates from user 118 are assigned to resource area 112 since its location coordinates are within the polygon defining the boundary of resource area 112. Updates from user 124 are discarded since user 124 is outside all resource areas.

Further, once the updates are assigned to a resource area, the location for each update assigned to particular resource area is checked to determine whether the location is also within any queue location in that resource area. If it is within a queue location, the update is assigned to that queue location. If a location is not within a queue location, the update is discarded.

Updates within a queuing location are analyzed and stored by location queuers 108. Each queue location has a location queuer 108. Location queuer 108 includes a queue data structure and an exit data structure. When a mobile device is determined to have entered a queue location, information for that device is stored in an element in the queue data structure. The information includes the mobile device's identification, the position of the mobile device, the time of measurement and the time that the mobile device entered the queue location. When a mobile device is determined to have exited the queuing data structure, its information is moved to an exit data structure. The information in the data structures is analyzed to determine the number of mobile devices in the queue, estimated waiting time, measured waiting time and the average speed of the line. In an embodiment, the times are stored in epoch times so as to simplify conversion between various time formats.

Although the use of GPS and WPS are assumed in this disclosure, those skilled in the art will understand that other technologies can be used. As an example, the mobile device may use Near Field Communication (NFC). With this technology the mobile device has an NFC reader that can read identification data stored on an NFC tag. In such an embodiment, NFC tags are placed at the queue location entrance and at the queue location exit.

When entering the queue location, the user places the mobile device near the tag at the queue location entrance and the device reads the tag identification. The mobile device sends an update containing the mobile device identification, the tag identification and the time of measurement. Computer 104 receives the update and uses the tag identification to identify the queue location and to determine that the user has entered the queue location. When exiting the queue location the user places the mobile device near the tag at the queue location. The device reads the tag identification and sends an update. Computer 104 receives the update and uses the update to determine that the user has exited the queue location.

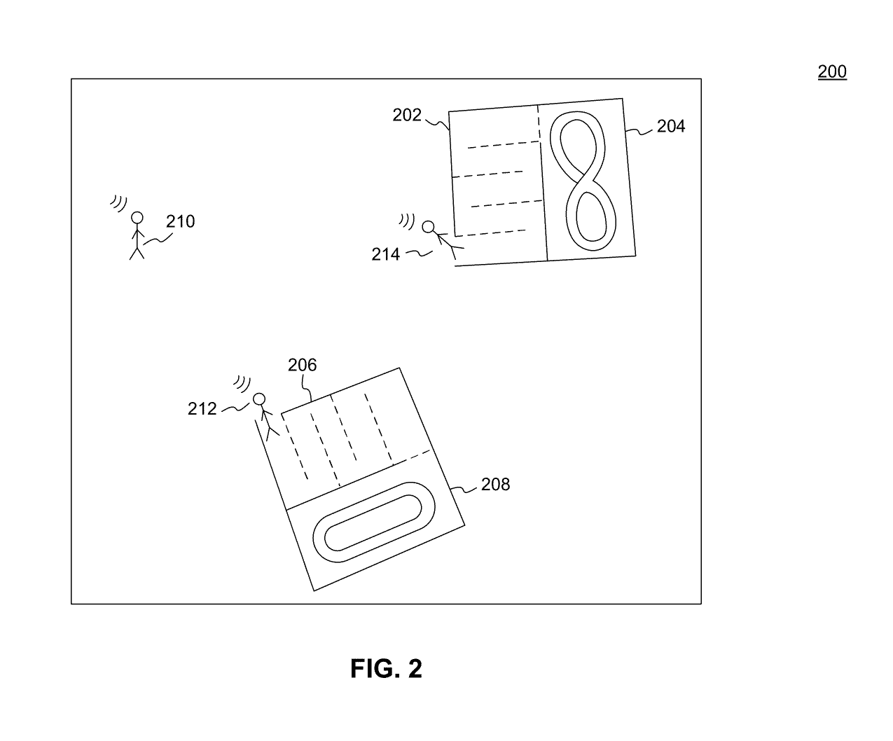

FIG. 2 shows resource area 200 (e.g., at an amusement park) with two resources, ride 204 and ride 208. Queue location 202 is the queue location for ride 204 and queue location 206 is the queue location for ride 208. The queue locations can be defined by polygons.

Three users are shown in resource area 200, each having a mobile device sending periodic updates containing its location (e.g., the latitude and longitude values of its location), its identity, and the time of measurement. User 210 is in the resource area but is not in or entering a queuing location. User 212 is entering queue location 206 and user 214 is entering queue location 202.

When an update is received from the mobile device for user 210, updates filter 106 checks the location to determine whether the mobile device is in either queue location 202 or queue location 206. For user 210, the mobile device is in neither queue location, so the update is discarded.

When an update is received from the mobile device for user 212, updates filter 106 checks the user's mobile location to determine whether the mobile device is in either queue location 202 or queue location 206. For user 212, the mobile device is in queue location 206, so the updates filter assigns the mobile device to that queue location.

The queuing locator for queue location 206 checks to see whether there are any other mobile devices in the queue data structure for queue location 206. In this case there are none, so the information about the mobile device for user 212 is stored in an element of the queue data structure for queue location 206. The information includes the mobile device's location and identification and the time of measurement. The time of update is also stored as the queue entrance time for that mobile device.

When an update is received from the mobile device for user 214, updates filter 106 checks the user's mobile location to determine whether the mobile device is in either queue location 202 or queue location 206. For user 214, the mobile device is in queue location 202, so the updates filter assigns the mobile device to that queue location.

The queuing locator for queue location 202 checks to see whether there are any other mobile devices in the queue data structure for queue location 202. In this case there are none, so the information about the mobile device for user 212 is stored in an element in the queue data structure for queue location 202.

In some embodiments, the exact location of the mobile device cannot be determined, but a footprint corresponding to a range of possible locations may be identified. For example, the location may be identified as a position circle having a certain radius of uncertainty around a given point. When only a position circle is available, additional steps are used to determine whether a mobile device is in a queue location. In an embodiment, when the entire circle is in a queue location, the mobile device is assigned to that queue location. When the entire circle is not within a queue location, the mobile device is not assigned to any queue location and the update is discarded. When at least one-half of the circle is within a queue location, one or more subsequent updates are monitored to determine if at least one-half of the circle remains within the queue location. When at least one-half of the circle remains within the queue location for the one or more subsequent updates, the update is assigned to that queue location. If the mobile device is not assigned to a queue location, the updates are discarded. One of skill in the art will recognize that other algorithms for the position circles may be used to determine whether a mobile device is located in a queue location.

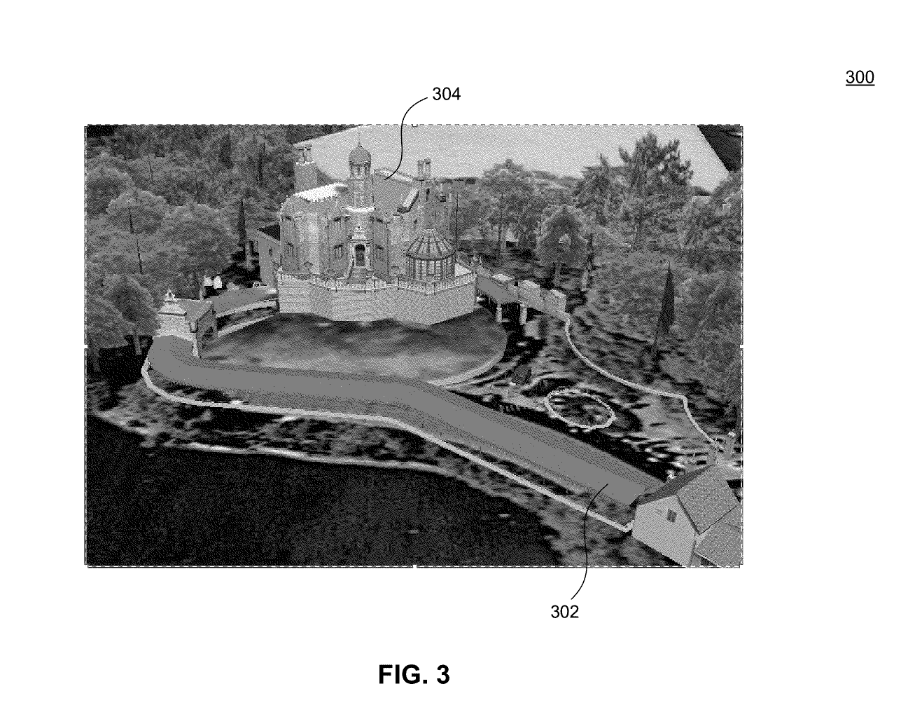

FIG. 3 is an aerial view of an example queuing location 302 for a resource 304 in an amusement park. The boundary of queuing location 302 can be approximately defined by a polygon and a satellite picture of the queuing location can be used to estimate the geographic locations of vertices of the polygon. When the location coordinates in an update from a mobile device fall within the polygon, the mobile device is assigned to queue location 302 as described in FIG. 2.

Other useful information may be gathered for a resource. For example, information about how a resource serves users would be useful in modeling the queue. A resource that is an attraction such as an exhibit would likely have a queue that moves in a fairly uniform manner as users enter the exhibit. On the other hand, a resource that is a ride may have a queue that moves in a stop and go fashion. The queue moves when users are boarding the ride and tends to be stationary while the ride is in progress. Knowing the capacity and duration of the ride may also be useful in modeling the queue, in some embodiments.

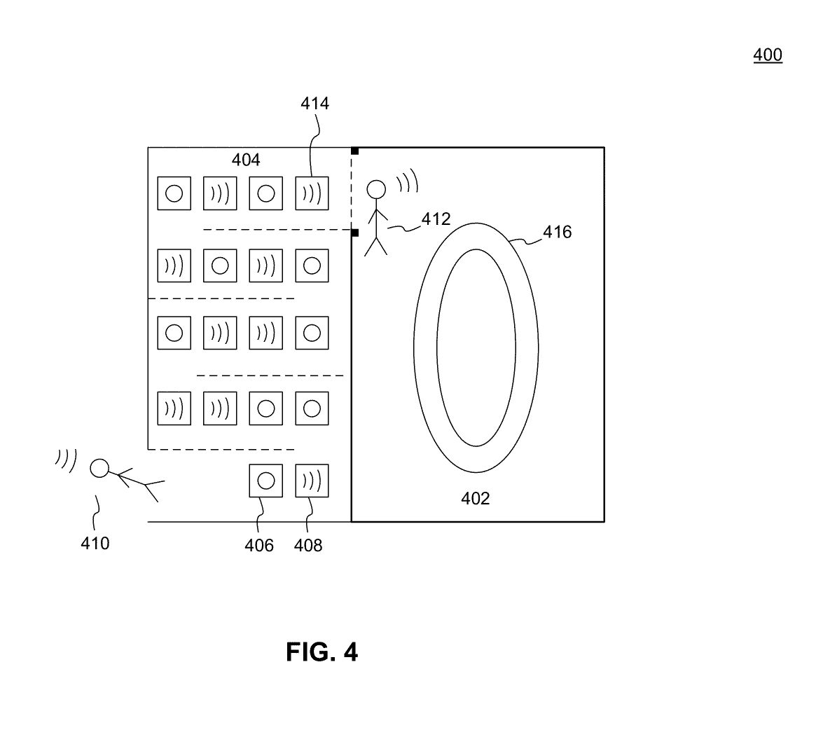

FIG. 4 will be used to explain example methods for adding information about mobile devices to the queue data structure, updating that information and moving that information to the exit data structure. Resource 400 includes ride location 402 and queue location 404. User 406 is a user in the queue location without a mobile device. User 408 and user 410 are users with mobile devices. User 408 is in the queue location and is already in the queue data structure. User 410 just entered the queue location and is not in the queue data structure.

When an update from a mobile device is received for a queue location, the identification in the update is compared to the identifications of devices in the queue data structure to determine whether that device is already in the queue location. If it is not in the queue data structure, the information for the device is inserted at the end of the queue data structure. The information includes one or more of the following: the identification of the mobile device, the location of the mobile device, the time of the measurement and the time of entry into the queue. If the device is already in the queue data structure, the location and time of measurement for that device in the queue data structure is changed to the values received in the update from the mobile device.

When a device is determined to have exited the queue location, information in the queue data structure for that device is moved to the end of the exit data structure (i.e., the information is stored in the exit data structure and deleted from the queue data structure). Two example methods for determining when a device exits a queue location are described below.

In the first example, user 412 has just left the queue location 404 and entered the ride location 402. Updates from the mobile device for user 412 will no longer be received in the queue location 412 and the time of measurement for the mobile device will no longer be updated in the queue data structure. With no updates, the difference between the current time and the time of measurement will increase. Consequently, a device can be determined to have exited a queue location when the difference between the current time and its time of measurement in the queue data structure exceeds some threshold. For example, if the updates from the mobile device occur every 30 seconds, then the threshold might be set to 90 seconds.

A second example relies on an embodiment where updates from the mobile device of user 412 is not be assigned to any queue location by computer 104 and will be discarded. Prior to discarding the update, computer 104 can check the identification in that update with the identification in elements in the queue data structure for each of the queue locations in the resource area. When there is a match for a particular queue location, user 412 is determined to have exited that queue location.

The queue in FIG. 4 includes users, like user 406, who do not have a mobile device sending updates to computer 104, intermixed with users, like user 408, who have a mobile device that is sending updates to computer 104. Information about queue lengths, measured waiting time and estimated waiting time is available based on users having mobile devices sending updates to computer 104.

An estimate of the percentage of users that have mobile devices sending updates can be obtained by first determining the minimum distances between adjacent mobile devices and the minimum distance between the mobile devices at the beginning of the queue and mobile devices at the queue location exit. Using, for example, industry statistics, the number of users that would typically stand in each of those distances is computed and summed over all minimum distances to obtain an estimate of the number of users without mobile devices. The number of users with a mobile device is obtained by counting the number of elements in the queue data structure. The percentage of users with mobile devices is obtained by dividing the number of users with mobile devices by the estimated sum of users with mobile devices and users without mobile devices. When that percentage is small, estimates of waiting time, for example, might not be accurate, so only estimates of measured waiting values would be provided by server 110 in FIG. 1.

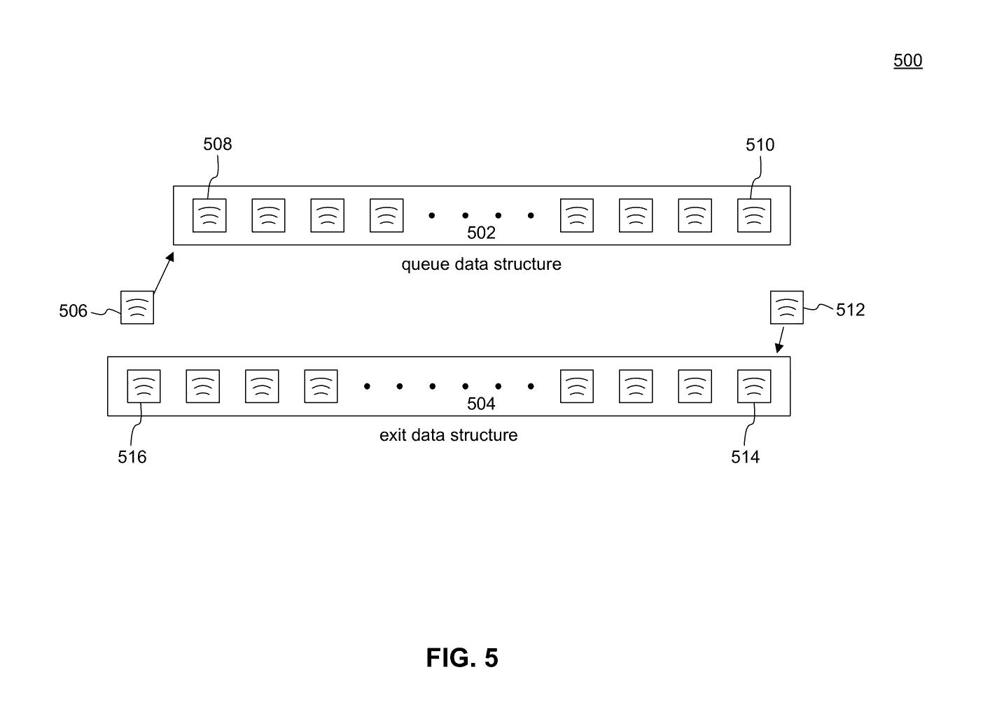

FIG. 5 shows the queue and exit data structures and will be used to describe the information in those structures and how that information is used to compute queue length, estimated waiting time, measured waiting time and the average speed of the line for devices in the queue. FIG. 5 includes queue data structure 502 and exit data structure 504. Each queue location is associated with a unique queue data structure and a unique exit data structure.

The queue data structure 502 includes queue elements, two of which are element 508 and element 510. Each element contains information stored for a particular mobile device, the information including the mobile device identification, the location of the mobile device, the time the location was measured and the time the mobile device entered the queue. An element represents the mobile device having the identification stored in the element and can considered a representation of the user carrying that mobile device. In that sense, the queue data structure, for example, identifies the position of users in the queue.

Element 508 is at the end of the queue and contains information for the most recent device to enter the queue. Element 510 is at the beginning of the queue and contains information for the next device that will exit the queue when the resource is available.

Element 506 includes information for a mobile device that has just entered the queue location but has not yet been added to the queue. When computer 104 determines that the device has entered the queue location, element 506 is inserted at the end of queue data structure 502.

Exit data structure 504 includes elements, two of which are element 514 and element 516. Each element is the information stored for a particular mobile device, including the mobile device identification, the location of the mobile device, the last time the location was measured and the time the mobile device entered the queue. For each element, the last time the location was measured is approximately the time the element exited the queue location.

Element 514 is at the end of the exit data structure and element 516 is at the beginning. Element 514 is the most recent element to have exited the queue location. Element 516 is the first element to have exited the queue since the exit data structure was initialized.

The information in the queue data structure and the exit data structure can be used to compute the number of mobile devices in the queue, the position of each device in the queue and estimated and measured values of waiting time. Waiting time is the difference between the time a mobile device (and the user carrying that mobile device) enters the queue and the time the mobile device exits the queue. Waiting times are estimated for devices in the queue and measured for devices that have exited the queue.

The values of measured waiting times are generally more reliable than the values of estimated waiting times but, unlike estimated waiting times, measured waiting times are not available until the device has exited the queue location. Thus, they may not be a good estimate of the waiting time for a device entering the queue. For example, if a device has a measured waiting time of one hour, that device entered the queue an hour earlier when the waiting time could be quite different. For short waiting times (e.g., on the order of minutes) the measured waiting time can be a reasonable estimate of the waiting time for a device entering the queue.

An approximate but simple method to estimate waiting time for the last element in a queue is to divide the number of elements in the queue by the average speed of the line. For example, if the device is at position 100 in the queue and the average speed of the line is 100 mobile devices per hour, then the estimated waiting time for that device is 1 hour.

The average speed of the line can be estimated using information in the exit data structure. For example, the number of elements at the end of the exit data structure in an interval of time T can be counted, and the count divided by T to compute the average speed of the line during the interval T.

The accuracy of a waiting time estimate for an element can be determined by comparing the estimate to the measured waiting time that is calculated when that element exits the queue. Those comparisons can be used to evaluate possible ways to improve the accuracy of the waiting time and average speed of line estimates. For example, the interval T can be varied to find the value that gives the most accurate results for each queue location.

The selection of an accurate method for measuring average speed of the line can depend on how the resource serves users. When users are queuing to enter an exhibit, for example, the line might move at a somewhat constant speed. In this case, the method described above (where the average speed of the line is determined by counting the number of devices in an interval T at the end of queue data structure and dividing the count by T) is likely to give reasonable results. However, if the resource is a ride, the people in line tend to move in a start and stop fashion. That is, the line will move when people are getting on the ride and the line will tend to be stationary while the ride is in progress

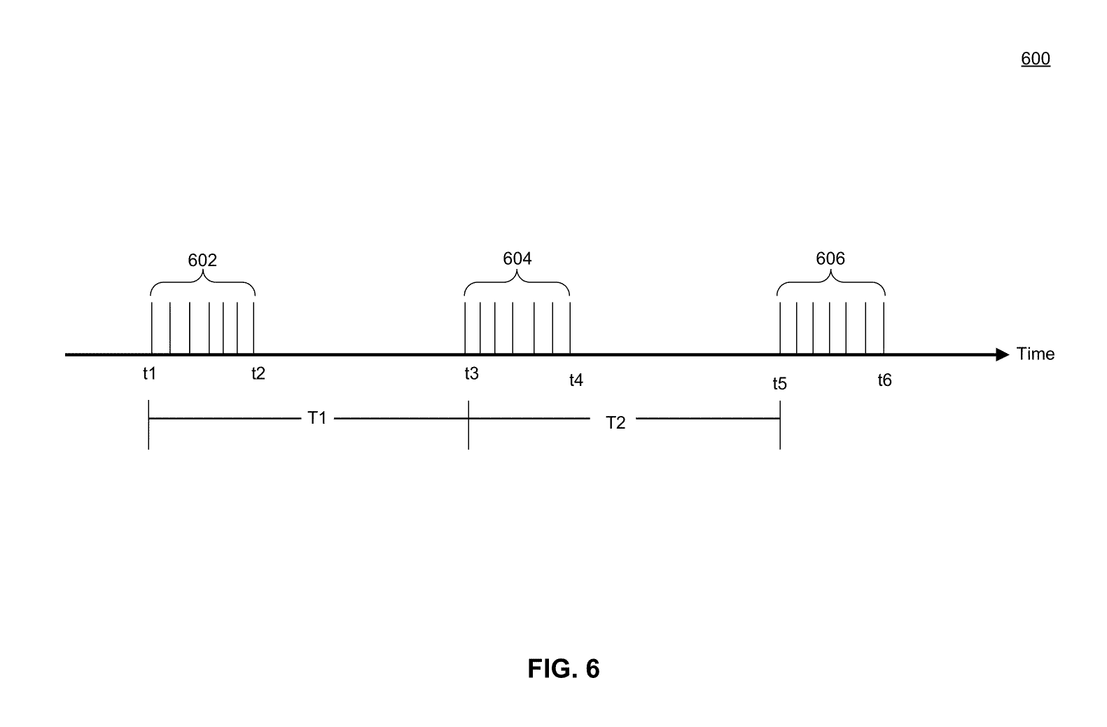

FIG. 6 shows a plot of when users exit the queue location as a function of time when the resource is a ride. Cluster 602 shows a number of users exiting the queue location (i.e., getting on the ride) between times t1 and t2. The line will be moving in the interval between t1 and t2. There is an interval between t2 and t3 while the ride is in progress before another set of users board the ride at cluster 604. The line will tend to be stationary during that interval. T1 is the period of the ride (measured from the time when the first user boards the ride to the completion of the ride) for cluster 602. The average speed of the line during this period is the number of users in cluster 602 divided by T1.

Similarly, another set of users board the ride at cluster 606. The period of that ride is T2. The average speed of the line during this period is the number of users in cluster 604 divided by T2. The number of users in cluster 604 can be different than the number in 602, so the speed of the line for period T2 can be different than for period T1. The average speed of the line can be determined by identifying the periods and computing the average speed over one or more recent periods.

The queue data structures and the exit data structures are initialized periodically by deleting their data, for example, at the beginning of each day. The exit data structure may be archived before it is initialized. Alternatively, the exit data structure may be archived continuously, removing all data that has been archived for a time greater than a threshold. Thus, the archive for each day contains a complete record of the operation of each resource for that day. The data in the archive can be analyzed, for example, to identify and determine the best ways to compute the average speed of the line for each queue.

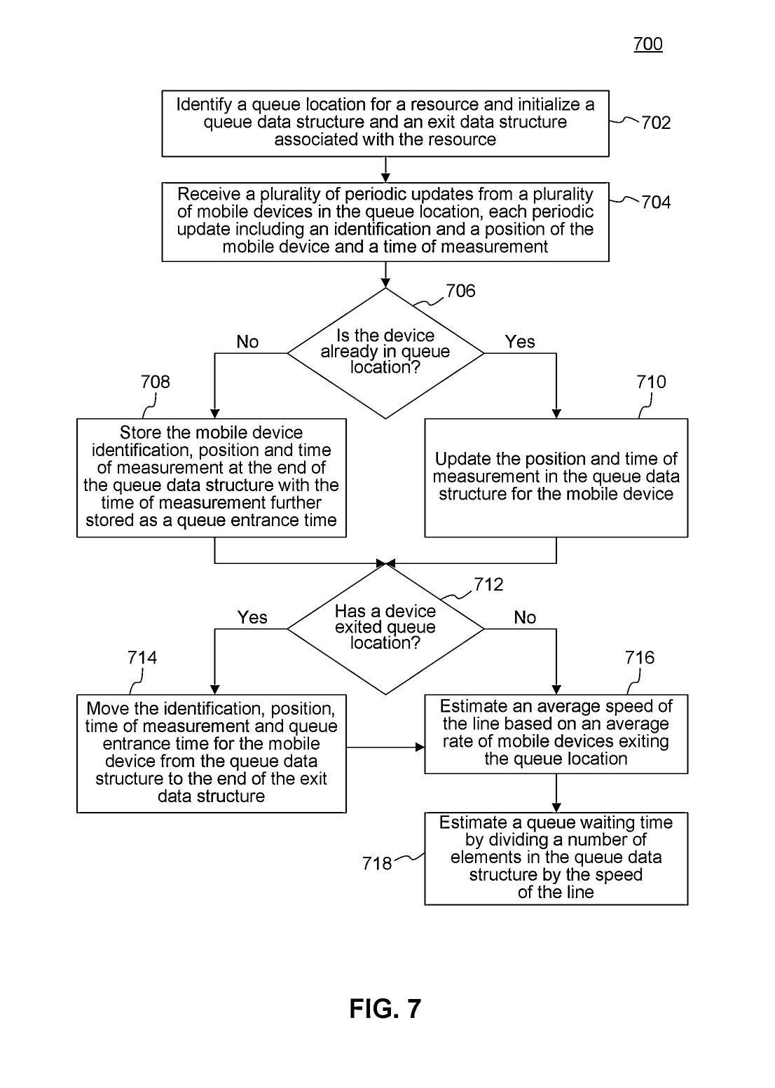

FIG. 7 is a flowchart of an example method of using location data from mobile devices to estimate length of queues and waiting times for users queuing to use a resource. One or more users in a queue location have a mobile device that sends updates of location and other information over wireless and/or wired networks to computer 104 in FIG. 1. Method 700 begins by identifying a queue location for a resource and initialing a queue data structure and an exit data structure associated with the resource at block 702. Referring back to FIG. 2, the queue location can be described as a polygon as shown, for example, by queue location 206.

Referring back to FIG. 5, queue data structure 502 contains elements that store information for each mobile device in the queue location. When a mobile device exits the queue location, the information is moved to the exit data structure 504. Both data structures are initialized periodically by deleting the information in the data structures. The information in exit data structure is archived before being deleted. The initialization is done, for example, at the beginning of each day of operation of the resource.

At block 704, a plurality of updates from a plurality of mobile devices in the queuing location is received by, for example, computer 104 in FIG. 1. The updates include an identification of the mobile device, a position of the mobile device and a time of measurement of the location of the mobile device.

Since the time for some mobile devices can be set manually, measurements may have errors. In some embodiments, each measurement is checked by computer 104 relative to its clock time adjusted to the time zone for the queue location. If the magnitude of the difference between the measured time and the time zone adjusted time is greater than a threshold (such as one minute), the measured value may be changed to the time zone adjusted time. In other embodiments, the mobile devices do not send a time of measurement, and computer 104 simply uses its own clock time at the time the information is received from the mobile device as the time of the location measurement.

At block 706 a determination is made as to whether the device sending the update is already in the queue location or the device has just entered the queue location. A device is determined to be already in the queue location when the device identification is the same as the device identification for one element in the queue data structure. Otherwise, the device is determined to have just entered the queue location.

If the device is not already in the queue location at block 706, the identification, location and time of measurement for the device is stored at the end of the queue data structure with the time of measurement further stored as the queue entrance time at block 708. If the device is already in the queue location at block 706, the position and time of measurement for that device is updated in the queue data structure at block 710.

Checks are made at block 712 to determine when a device has exited a queue location. As described for FIG. 4, various methods can be used to determine when a device exits a queue location. For example, when a mobile device exits a queue location, updates from that device will no longer be received in the queue location and the time of measurement for that mobile device will no longer be updated in the queue data structure. With no updates, the difference between the current time and the time of measurement will increase. Consequently, a device can be determined to have exited a queue location when the difference between the current time and its time of measurement exceeds some threshold. For example, if the updates from that mobile device occur every 30 seconds, the threshold may be set to 90 seconds.

Another example relies on the likelihood that a mobile device that has just exited a queue location will not at that same time be in any other queue location. Referring back to FIG. 4, user 412 has just exited queue location 404 and is now in ride location 402. Updates for a device not in a queue location are discarded. Prior to discarding the update, computer 104 may check the identification in each update with the identification in elements in the queue data structure for each of the queue locations. When there is a match for a particular queue location, the element containing that identification is determined to have exited that queue location.

When it is determined that a device has exited a queue location at block 712, the information for that device is moved from the queue data structure to the exit data structure at block 714. If a device has not exited the queue location, or after block 714, the average speed of the line is estimated at block 716. At block 718, the waiting time for the last element in the queue is estimated by dividing a number of elements in the queue data structure by the speed of the line. As described in connection with FIG. 5 and FIG. 6, the most accurate methods for calculating the speed of the line and for estimating waiting time can be determined for each of the queue locations.

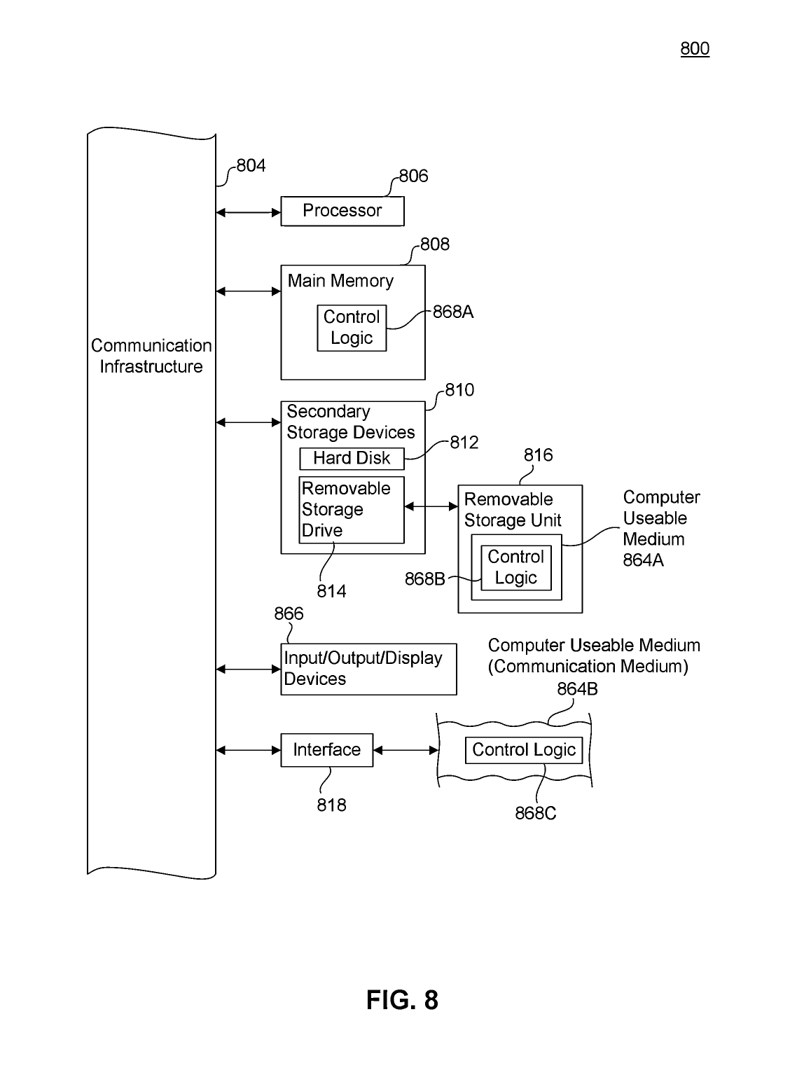

In an embodiment, the system, methods and components of embodiments described herein are implemented using one or more computers, such as example computer 800 shown in FIG. 8. Computer 800 can be any commercially available and well known computer capable of performing the functions described herein.

Computer 800 includes one or more processors (also called central processing units, or CPUs), such as a processor 806. Processor 806 is connected to a communication infrastructure 804.

Computer 800 also includes a main or primary memory 808, such as random access memory (RAM). Primary memory 808 has stored therein control logic 868A (computer software), and data.

Computer 800 also includes one or more secondary storage devices 810. Secondary storage devices 810 include, for example, a hard disk drive 812 and/or a removable storage device or drive 814, as well as other types of storage devices, such as memory cards and memory sticks. Removable storage drive 814 represents a floppy disk drive, a magnetic tape drive, a compact disk drive, an optical storage device, tape backup, etc.

Removable storage drive 814 interacts with a removable storage unit 816. Removable storage unit 816 includes a computer useable or readable storage medium 864A having stored therein computer software 868B (control logic) and/or data. Removable storage unit 816 represents a floppy disk, magnetic tape, compact disk, DVD, optical storage disk, or any other computer data storage device. Removable storage drive 814 reads from and/or writes to removable storage unit 816 in a well-known manner.

Computer 800 may also include input/output/display devices 866, such as monitors, keyboards, pointing devices, Bluetooth devices, etc.

Computer 800 further includes a communication or network interface 818. Network interface 818 enables computer 800 to communicate with remote devices. For example, network interface 818 allows computer 800 to communicate over communication networks or mediums 864B (representing a non-storage form of a computer useable or readable medium), such as LANs, WANs, the Internet, etc. Network interface 818 may interface with remote sites or networks via wired or wireless connections.

Control logic 868C may be transmitted to and from computer 800 via communication medium 864B.

Any tangible apparatus or article of manufacture comprising a computer useable or readable storage medium having control logic (software) stored therein is referred to herein as a computer program product or program storage device. This includes, but is not limited to, computer 800, main memory 808, secondary storage devices 810 and removable storage unit 816. Such computer program products, having control logic stored therein that, when executed by one or more data processing devices, cause such data processing devices to operate as described herein, represent the embodiments.

Embodiments can work with software, hardware, and/or operating system implementations other than those described herein. Any software, hardware, and operating system implementations suitable for performing the functions described herein can be used. Embodiments are applicable to both a client and to a server or a combination of both.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer implemented method, comprising:
identifying, by a computing device, a queue location for a resource and initializing a queue data structure and an exit data structure associated with the resource;
receiving, by the computing device, a plurality of periodic updates from a plurality of mobile devices in the queue location, each periodic update including an identification of the mobile device, a position of the mobile device, and a time of measurement;
when a mobile device is determined to have entered the queue location, storing, by the computing device, the mobile device identification, position and time of measurement at the end of a queue data structure with the time of measurement further stored as a queue entrance time;
when a mobile device is determined to be already in the queue location, updating, by the computing device, the position and time of measurement in the queue data structure;
when a mobile device is determined to have exited the queue location, moving, by the computing device, the identification, position, time of measurement and queue entrance time for the mobile device from the queue data structure to the exit data structure;
estimating, by the computing device, an average speed of the line based on an average rate of mobile devices exiting the queue location; and
estimating, by the computing device, a queue waiting time based on dividing a number of elements in the queue data structure by the average speed of the line.

2. The method of claim 1, further comprising:
storing in a web server the estimated average speed of the line, the estimated queue waiting time, the queue location, a time of day and a date.

3. The method of claim 1, wherein identifying the queue location comprises:
receiving one or more of the following: geographic coordinates of a polygon defining the boundary of the queue location, geographic coordinates of an entrance to the queue location, geographic coordinates of an exit to the queue location, and traffic handling characteristics of the resource.

4. The method of claim 1, wherein a mobile device is determined to have entered the queue location when the device identification is different from device identifications from other devices in the queue data structure.

5. The method of claim 1, wherein a mobile device is determined to be already in the queue location when the device identification is the same as the device identification for one device in the queue data structure.

6. The method of claim 1, wherein a mobile device is determined to have exited the queue location when a current time minus the time of measurement for the device in the data queue structure exceeds a defined threshold.

7. A system, comprising:
at least one computing device; and
a memory coupled to the computing device and having instructions stored thereon that, when executed by the computing device, cause the computing device:
identify a queue location for a resource and initializing a queue data structure and an exit data structure associated with the resource;
receive a plurality of periodic updates from a plurality of mobile devices in the queue location, each periodic update including an identification of the mobile device, a position of the mobile device, and a time of measurement;
when a mobile device is determined to have entered the queue location, store the mobile device identification, position and time of measurement at the end of a queue data structure with the time of measurement further stored as a queue entrance time;
when a mobile device is determined to be already in the queue location, update the position and time of measurement in the queue data structure;
when a mobile device is determined to have exited the queue location, move the identification, position, time of measurement and queue entrance time for the mobile device from the queue data structure to the exit data structure;
estimate an average speed of the line based on an average rate of mobile devices exiting the queue location; and
estimate a queue waiting time based on dividing a number of elements in the queue data structure by the average speed of the line.

8. The system of claim 7, wherein the instructions further cause the computing device to:
store in a web server the estimated average speed of the line, the estimated queue waiting time, the queue location, a time of day and a date.

9. The system of claim 7, wherein the instructions that cause the computing device to identify the queue location further cause the computing device to:
receive one or more of the following: geographic coordinates of a polygon defining the boundary of the queue location, geographic coordinates of an entrance to the queue location, geographic coordinates of an exit to the queue location, and traffic handling characteristics of the resource.

10. The system of claim 7, wherein a mobile device is determined to have entered the queue location when the device identification is different from device identifications from other devices in the queue data structure.

11. The system of claim 7, wherein a mobile device is determined to be already in the queue location when the device identification is the same as the device identification for one device in the queue data structure.

12. The system of claim 7, wherein a mobile device is determined to have exited the queue location when a current time minus the time of measurement for the device in the data queue structure exceeds a defined threshold.

13. A computer readable storage medium having instructions encoded thereon that, when executed by a computing device, cause the computing device to:
identify a queue location for a resource and initializing a queue data structure and an exit data structure associated with the resource;
receive a plurality of periodic updates from a plurality of mobile devices in the queue location, each periodic update including an identification of the mobile device, a position of the mobile device, and a time of measurement;
when a mobile device is determined to have entered the queue location, store the mobile device identification, position and time of measurement at the end of a queue data structure with the time of measurement further stored as a queue entrance time;
when a mobile device is determined to be already in the queue location, update the position and time of measurement in the queue data structure;
when a mobile device is determined to have exited the queue location, move the identification, position, time of measurement and queue entrance time for the mobile device from the queue data structure to the exit data structure;
estimate an average speed of the line based on an average rate of mobile devices exiting the queue location; and
estimate a queue waiting time based on dividing a number of elements in the queue data structure by the average speed of the line.

14. The computer readable storage medium of claim 13, wherein the instructions further cause the computing device to:
store in a web server the estimated average speed of the line, the estimated queue waiting time, the queue location, a time of day and a date.

15. The computer readable storage medium of claim 13, wherein the instructions that cause the computing device to identify the queue location further cause the computing device to:
receive one or more of the following: geographic coordinates of a polygon defining the boundary of the queue location, geographic coordinates of an entrance to the queue location, geographic coordinates of an exit to the queue location, and traffic handling characteristics of the resource.

16. The computer readable storage medium of claim 13, wherein a mobile device is determined to have entered the queue location when the device identification is different from device identifications from other devices in the queue data structure.

17. The computer readable storage medium of claim 13, wherein a mobile device is determined to be already in the queue location when the device identification is the same as the device identification for one device in the queue data structure.

18. The computer readable storage medium of claim 13, wherein a mobile device is determined to have exited the queue location when a current time minus the time of measurement for the device in the data queue structure exceeds a defined threshold.
